(19) United States
(12) Patent Application Publication
(10) Pub. No.: US 2026/0105172 A1
(43) Pub. Date: Apr. 16, 2026

(54) RAG ENHANCEMENT FOR PRIVACY AND SECURITY

(71) Applicant: Lenovo (United States) Inc., Morrisville, NC (US)

(72) Inventors: Rod D Waltermann, Rougemont, NC (US); Sergei Rodionov, Plano, TX (US); Igor Stolbikov, Apex, NC (US); Javier Guillermo, Dallas, TX (US); Scott Li, Cary, NC (US)

(21) Appl. No.: 18/916,191

(22) Filed: Oct. 15, 2024

(51) Int. Cl. G06F 21/62; G06F 16/242

(52) U.S. Cl. CPC G06F 21/6218; G06F 16/243

(57) ABSTRACT

A computer implemented method includes receiving a prompt and generating a query based on the prompt. A first data source having original data with different classifications is accessed to obtain first data source data responsive to the query. The obtained first data source data is processed to generate curated data. The curated data and prompt is provided to a large language model. A first language response is received from the large language model based on the curated data and the prompt.

### BACKGROUND

Retrieval-Augmented Generation (RAG) is a means to provide supplemental or augmented data to a large language model (LLM) to provide context beyond LLM core training. While RAG systems enable more knowledgeable LLM responses, they retrieve supporting information/context from non-vetted internet sources that may possibly be combined with proprietary information of the organization.

Much information on the Internet, which is used to train LLMs, is unverified while the proprietary source of information accessible to RAG systems is often sensitive (personal, classified, regulated, etc.) and should not be readily published or otherwise disclosed.

If unverified or proprietary information is used directly in RAG generated responses, users could be exposed to misinformation, privacy violations for personal information may occur, or violations of copyrighted, regulated, or classified information may occur.

### SUMMARY

A computer implemented method includes receiving a prompt and generating a query based on the prompt. A first data source having original data with different classifications is accessed to obtain first data source data responsive to the query. The obtained first data source data is processed to generate curated data. The curated data and prompt is provided to a large language model. A first language response is received from the large language model based on the curated data and the prompt.

### BRIEF DESCRIPTION OF THE DRAWINGS

FIG. 1 is a block flow diagram of an improved RAG system according to an example embodiment.

FIG. 2 is a block flow diagram of an alternative RAG system according to an example embodiment.

FIGS. 3A and 3B are a flow diagram illustrating actions between actors performed in processing of context data prior to use in RAG based systems according to an example embodiment.

FIG. 4 is a flowchart illustrating a method of augmenting LLM responses using additional data that may include sensitive information while avoiding unauthorized disclosure of the sensitive information to the LLM according to an example embodiment.

according to an example embodiment.

FIG. 5 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

RAG (Retrieval-Augmented Generation) systems combine neural information retrieved from private or proprietary data stores with generative language models to provide responses to questions or other prompts. LLMs (large language models) like GPT-3 can generate convincing text, at lighting speed, but lack grounding in knowledge/facts.

RAG systems retrieve relevant context information which may include sensitive data, such as proprietary, confidential, personal information, and other information to inform LLM responses. The context information may be either provided to the LLM as part of a prompt, separately used to augment LLM generated text, or both.

In prior RAG systems, relevant context information may be in the form of documents or files that are divided into chucks of text for which embeddings are created and stored as vectors in a vector library. When a prompt from a user is received for an LLM, without using the stored vectors, a generated response lacks any context information. For an example prompt of: “What is the name of the telco project Jane emailed me about,” the LLM may answer: “I am sorry Dave, I am afraid I don't have access to that information.”

However, when the stored vectors are provided to the LLM along with the prompt, the answer may change to: “Dave, Jane emailed you on October 10^{th} at 11:00 AM last year. The project was called SDN networks.” This context information enhanced response provides the user a factual answer to the prompt. However, the provision of the stored vectors to the LLM may reveal sensitive information. Further, the response may also contain sensitive information that the user is not authorized to see. An example prompt that may reveal sensitive information may be: “What is Jane's social security number?” Jane's social security number should not be provided to an unsandboxed LLM, and may not be appropriate for Dave to see.

A further problem occurs when the sensitive data is used to further train the LLM, which may be triggered by providing feedback to the LLM by a user.

Some solutions already exist that attempt to tokenize sensitive data at rest and then recombine it in output. However one can safely assume that cost of re-tokenizing existing storages can be vast and requires massive investment.

Providing sensitive data to the LLM risks unauthorized disclosure of such data to third parties. Using sensitive data to augment already LLM generated text can also result in disclosure of sensitive information to users generating the prompts who should not have access to the sensitive information.

An improved RAG system includes one or more mechanisms to avoid undesired disclosure of sensitive information while providing augmented LLM generated text that is more responsive to prompts.

The improved RAG system operates to curate potentially sensitive data by vetting, filtering, or otherwise processing data retrieved from data sources before tokenizing the retrieved information and feeding the tokens to an LLM, by applying classification filters backed by RBAC system along with tokenization, as well as applying secondary layer of protection by applying dynamic redaction, anonymization, and re-tokenization.

Upon generation of a response by the LLM utilizing retrieved information, reassembly of the output occurs through token-level filtering and redaction based on the role-based access control (RBAC) level of the user and a predetermined classification levels of the original data tokens incorporated into the response.

For data that is based on statistical distributions, techniques like differential privacy will be used to curate data that can still be used for predicting trends or anomalous activity without leaking the actual confidential data. Differential privacy is a mathematical framework for ensuring the privacy of individuals in datasets. It can provide a strong guarantee of privacy by allowing data to be analyzed without revealing sensitive information about any individual in the dataset. In one example, rather than using actual data, a statistical distance from a norm or average of data may be provided. The statistical distance is meaningful yet hides the actual data which may be sensitive.

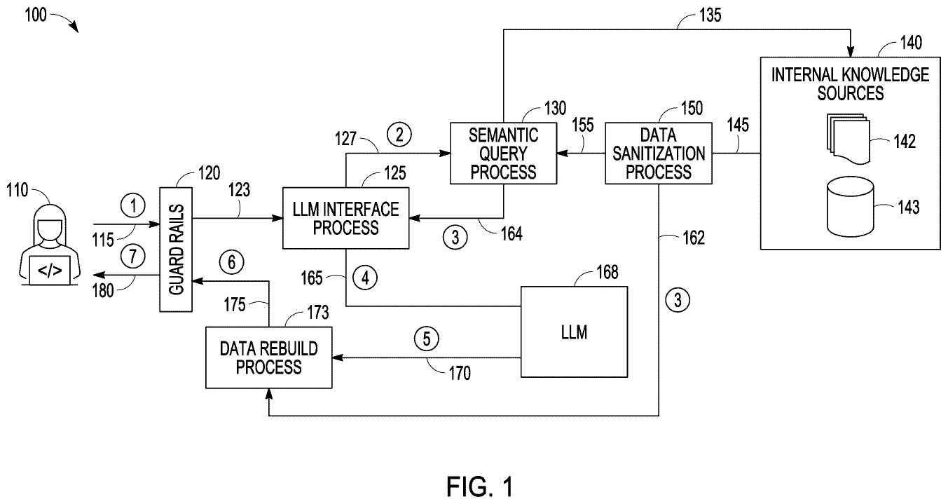

FIG. 1 is a block flow diagram of an improved RAG system 100. RAG system 100 accepts a user 110 prompt 115 and applies guard rails 120 to the prompt. The guard rails 120 may be a standard set of safety controls that typically monitor and dictate a user's interaction with an LLM system. In one example, the guard rails 120 include a language model designed to check if a user prompt is asking something that is relevant in the context in which the RAG system 100 is being used. For example, in a technical support environment, prompts regarding medical or tax advice would not be relevant and would not be forwarded on for further processing by RAG system 100. The guard rails 120 may help eliminate processing costs associated with non-relevant prompts, saving time and processing resources for relevant prompts.

Following application of the guard rails 120 to the prompt 115, a modified prompt 123 is provided to an LLM interface process 125. The LLM interface process generates a RAG query 127 provided to a semantic query process 130, which formats the RAG query 127 into a query 135 formatted for one or more internal knowledge sources 140.

Query 135 may include multiple queries designed for different sources of the internal knowledge sources 140. Internal knowledge sources 140 may include documents 142 and databases 143, which each may be queried using different strategies and each may contain many different forms of sensitive data, from confidential business and technical data to personal information. Documents 142 may include emails and calendar information as well as word processing types documents to name a few. Databases 143 may also contain sensitive data in relational or other form.

Results 145 of the query 135 may include sensitive data. The results 145, in the form of tokenized vectors, are provided to a data sanitization process 150 which may curate the data by applying differential privacy or data masking to remove or identify sensitive information. Data sanitization process 150 provides sanitized or curated results 155 back to semantic query process 130, which generates an enhanced context query response 164 and a confidential context query response 162 that may include sensitive information.

LLM interface process 125 receives the enhanced context query response 164. Query responses and the prompt may be tokenized by LLM interface process 125 using standard embedding and tokenization tools to create. LLM interface process 125 then generates an LLM prompt 165 that includes the enhanced context query response 164 and is provided to an LLM 168. LLM 168 then generates a text response 170 that is provided to a data rebuild process 173.

Data rebuild process 173, updates the text response 170 with sensitive data comprising the confidential context query response 162 to construct a confidential response 175. The data rebuild process essentially looks at the text response 170 and finds relevant data from 162, that needs to be merged back in to create a confidential answer that would include the sensitive data from the original sources.

Data rebuild process 173 may also implement access control checks to ensure only data the use is authorized to access is used in building a response.

The confidential response 175 is provided back to guard rails 120 which modifies the response ad provides a final text response 180 back to user 110. The guard rails 120 validate that the user 110 is authorized to see data in the response, and again determine whether the response is relevant in the context of RAG system 100. Assuming the user 110 is authorized, and the response is relevant, the final text response 180 is provided. In a sense, guard rails 120 can help prevent attempts by users, referred to as social engineering, to trick RAG system 100 from providing data, such as PII, that is not relevant to the context of RAG system 100.

In one example, the data rebuild process 173 receives the confidential context query response 162 for use in generating the confidential response 175.

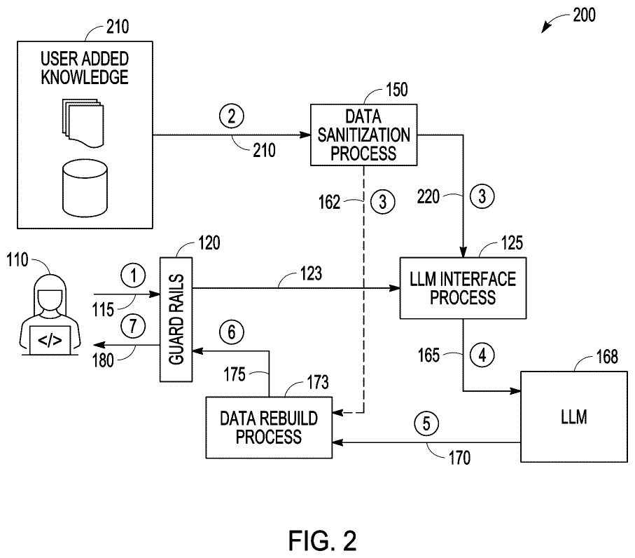

FIG. 2 is a block flow diagram of an alternative RAG system 200. System 200 utilizes components that are similar to those in RAG system 100 and uses like reference numbers for like components. System 200 differs from RAG system 100 in that user 110 directly shares user added knowledge 210 for providing user added context 215 in addition to providing user prompt 115. User added context is provided to data sanitization process 150 to apply one or more or differential privacy or data masking to provide safe enhanced context 220 to LLM interface process 125.

LLM interface process 125 receives the modified prompt 123 and combines it with the safe enhanced context 220 to generate the LLM prompt 165 for LLM 168. LLM 168 generates the text response 170 which is provided to data rebuild process 173 which generates the confidential response 175. Data rebuild process 173 may also receive the confidential context query response 162 from data sanitization process 150. The confidential response 175 is provided back to guard rails 120 which modifies the response ad provides a final text response 180 back to user 110.

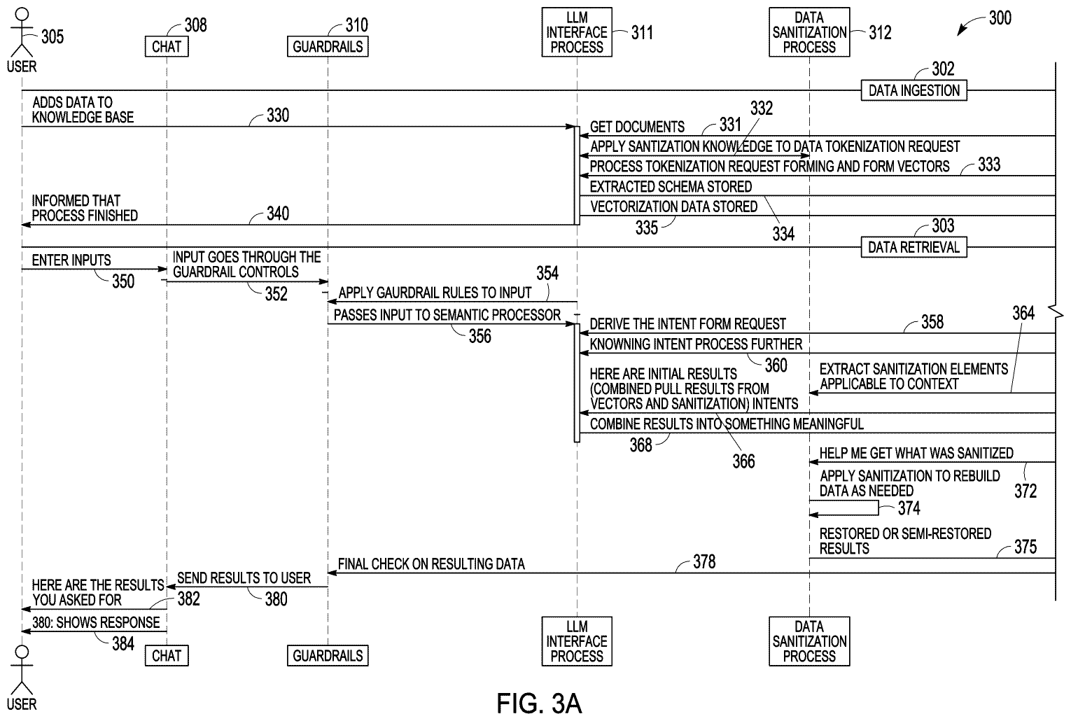

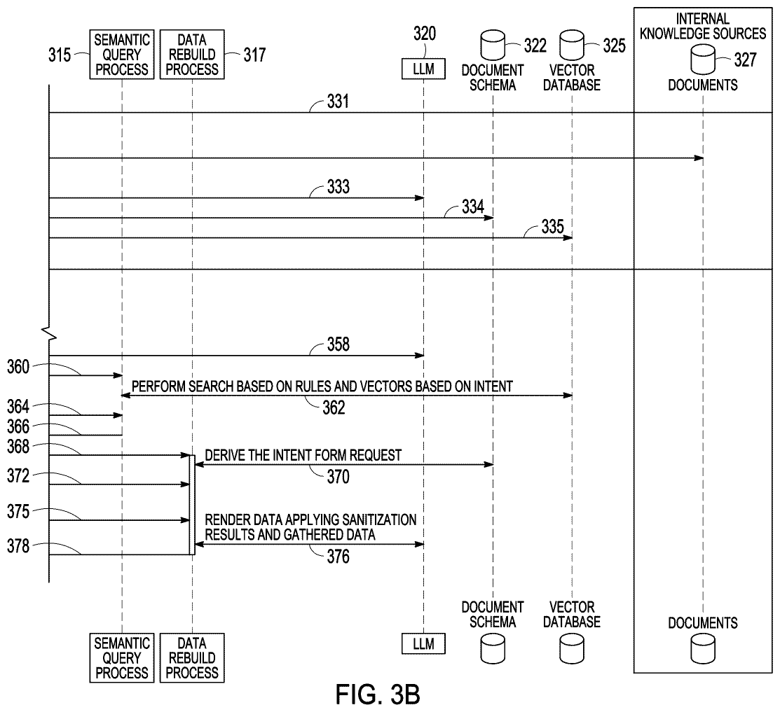

FIGS. 3A and 3B are a flow diagram illustrating actions between actors performed in processing of context data prior to use in RAG based systems followed be data retrieval generally at 300. Data ingestion 302 involves obtaining context data to augment LLM responses, sanitization, and vectorization of the context data.

Sanitization may be used to remove any personally identifiable information (PII), confidential, and other prohibited data, referred to as sensitive data. Techniques such as data masking, differential privacy, along with semantic analysis, and pattern matching may be used to remove or mask such data.

Data retrieval 303 and involves several steps by many different actors to provide RAG enhanced responses to prompts.

Processing actions for both data ingestion 302 and data retrieval 303 are shown in columns indicating processing between different actors involved in the processing. The actors include a user 305, a chat device 308, guardrails 310, data sanitization process 312, semantic query process 315, data rebuild process 317, LLM 320, document schema 322, vector database 325, and internal knowledge source documents 327.

Chat device 308 is basically a user interface for both data ingestion 302 and receiving prompts from user 305 and providing responses to user 305 for data retrieval 303.

A subset of the actors is used for data ingestion 302. User 305 may select data to add to a knowledge base at 330 and provide the data to LLM interface process 311. Interface process 311 gets documents at 331 from document 327, applies the sanitization process 312 to the documents at 332, uses LLM 320 via a tokenization request 333 to tokenize data in the documents and form vectors, extract, at 334, a stored schema from document schema 322, and store the vectorized data at 335 into vector database 325. LLM interface process 311 then informs the user 305 that the data ingestion 302 process is finished at 340.

Data sanitization process 312 includes data sanitation and data rebuild. Document schema 322 provides information regarding the schema of data stored in documents 327 that are used to augment LLMs in answering prompts and that may contain sensitive information.

Data retrieval 33 begins with an input at 350 by the user 305. The input may be text provided to chat device 308 in the form of a prompt. Chat device 308 provides the input at 352 to guardrails 310, which interfaces with LLM Interface process 311 at 354 to apply guardrail rules to the input. Guardrails passes the resulting input for semantic processing via 356 to LLM interface process 311.

LLM interface process 311 uses the LLM 320 at 358 to derive intent from the input, also referred to as a request. Once the intent is known, LLM interface process 311 utilizes semantic query process 315 at 360 to generate a search based on rules and vectors based on intent. A search request 362 is sent to the vector database for retrieval of relevant vectors.

The semantic query process 315 uses the data sanitization process 312 at 364 to extract sanitization elements applicable to context data, and then provides initial results to the LLM interface process 311 at 366. The initial results may include a combination of pull results from vectors and sanitization intents.

LLM interface process 311 combines the initial results 366 and input on 356 to generate a meaningful request. The meaningful request is provided at 368 to the data rebuild process 317, which gets documents from document schema 322 as needed. Data rebuild process 317 the requests help from data sanitization process 312 to obtain sanitized data. Data sanitization process 312 performs the sanitization at 374 and provides the sanitized results back to the data rebuild process 317 via 375. Data sanitization process 312 operates to remove PII, confidential, and other prohibited data. Techniques such as data masking, differential privacy, along with semantic analysis, and pattern matching may be used.

Data rebuild process 317 engages with LLM 320 at 376 to render data applying sanitization results (added context) and generated results from the LLM 320. At 378, the data rebuild process 317 provides the resulting data to the guardrails 310 for a final check on the resulting data. Results are provided at 380 from the guardrails 310 to the chat device 308 and then to the user at 382 and 384.

In one example, data sanitization process 312 may perform a blackout of content may occur and result in an output in the form of a randomized token that appears like this: “<<<<IEC AUTHORUTY:REDACTED:Feb. 9, 2024:ID: KrQu5hCIok6NsxY6L2bxJAAS>>>>>>>>>>>>”

An example of differential privacy application is now provided in the context of scouts selling chocolate bars to raise money. Chocolate bars are sold by various scout groups. Scouts, parents, and leadership all need to have access to this data about sales. Example rules should enable the following access rights. A parent should be able to see data about their child. A scout squad leader should be able to see their squad's data. A member of leadership should be able to see data across all squads.

Based on the above rules, data access results will be presented as follows:
1. The original, non-obfuscated data is stored and classified based on sensitivity levels:
Scout Group A: 250 (Classified: Squad-Level)
Scout Group B: 175 (Classified: Squad-Level)
Scout Group C: 320 (Classified: Squad-Level)
Scout Group D: 195 (Classified: Squad-Level)
2. Differential privacy is applied to the full dataset to create an obfuscated version for general analysis:
Scout Group A: 0.56
Scout Group B: 0.2
Scout Group C: 0.84
Scout Group D: 0.35
3. The LLM 168 ingests and learns from the obfuscated dataset during training or during query processing if data is provided directly.
4. At query time, the LLM 168 generates responses based on its knowledge. These responses contain snippets/tokens from the original classified data.
5. An RBAC filter is applied that reassembles and redacts the LLM output based on the user's role:

### Parent:

Sees the obfuscated data version
   Scout (e.g. from Group A):
Sees their own squad's real data: “Scout Group A: 250 chocolate bars sold”
Does not see other squads'data

### Leadership:

Sees the original, non-obfuscated data for all groups

This way, the data ingested by the LLM is privacy-preserved via differential privacy. The LLM outputs are filtered by an RBAC policy engine that reassembles responses using the original classified data tokens, showing each user only what their role permits.

Parents see obfuscated data for analysis, protecting individual squad details. Scouts see just their own squad's real figures for tracking. And leadership can access the complete, accurate dataset across all squads for monitoring performance.

The differential privacy obfuscation allows meaningful modeling by the LLM, while the RBAC filter enforces need-to-know data access principles on the LLM's responses.

Alternately, this method also applies to real time data uploading. The method can run autonomously as a pre and post processing service for general knowledge augmentation.

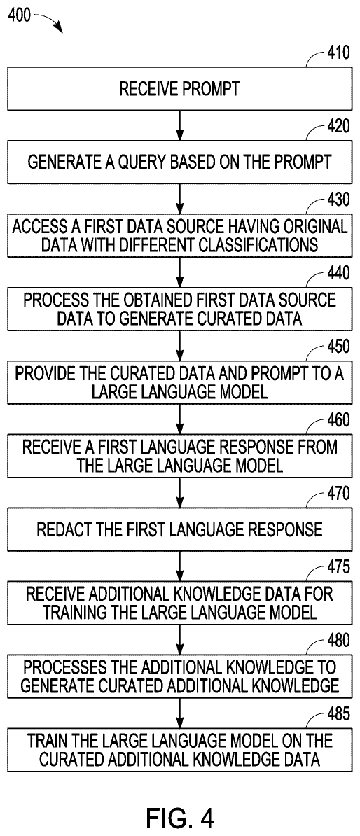

FIG. 4 is a flowchart illustrating a method 400 of augmenting LLM responses using additional data that may include sensitive information while avoiding unauthorized disclosure of the sensitive information to the LLM. Method 400 begins at operation 410 by receiving a prompt. Operation 420 generates a query based on the prompt. A first data source having original data with different classifications is accessed at operation 430 to obtain first data source data responsive to the query. Operation 440 processes the obtained first data source data to generate curated data. Processing the obtained first data source data to generate curated data may be performed based on application of differential privacy and the different classifications of the original data or based on role based access control of a user associated with the query.

The curated data and prompt is provided to a large language model at operation 450. Operation 460 receives a first language response from the large language model based on the curated data and the prompt. The first language response may be redacted at operation 470 based on a role-based access control (RBAC) level of a user associated with the prompt and classification levels of original data included in the first language response. In a further example, redacting the first language response may be based on a differential privacy associated with a user associated with the prompt.

In one example, method 400 may include receiving, at operation 475, additional knowledge data for training the large language model. Operation 480 processes the additional knowledge data to generate curated additional knowledge data with different classifications. The large language model is trained on the curated additional knowledge data at operation 485. Flow may then return to operation 410 to receive another prompt and process the prompt using the additional knowledge data.

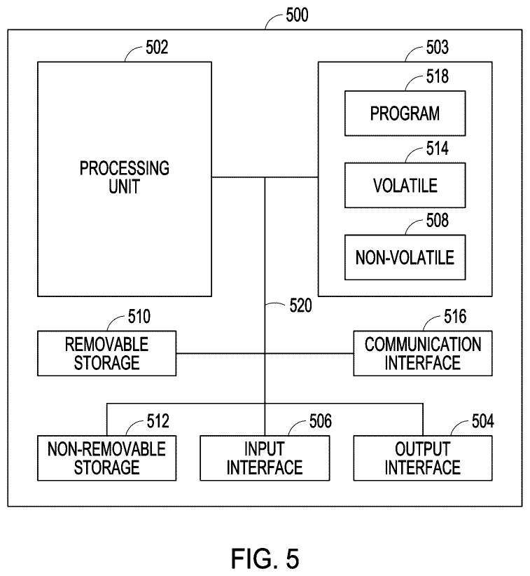

FIG. 5 is a block schematic diagram of a computer system 500 to implement the improved RAG system that avoids undesired disclosure of sensitive information while providing augmented LLM generated text that is more responsive to prompts, and for performing methods and algorithms according to example embodiments. All components need not be used in various embodiments.

One example computing device in the form of a computer 500 may include a processing unit 502, memory 503, removable storage 510, and non-removable storage 512. Although the example computing device is illustrated and described as computer 500, the computing device may be in different forms in different embodiments. For example, the computing device may instead be a smartphone, a tablet, smartwatch, smart storage device (SSD), or other computing device including the same or similar elements as illustrated and described with regard to FIG. 5. Devices, such as smartphones, tablets, and smartwatches, are generally collectively referred to as mobile devices or user equipment.

Although the various data storage elements are illustrated as part of the computer 500, the storage may also or alternatively include cloud-based storage accessible via a network, such as the Internet or server-based storage.

Note also that an SSD may include a processor on which the parser may be run, allowing transfer of parsed, filtered data through I/O channels between the SSD and main memory.

Memory 503 may include volatile memory 514 and non-volatile memory 508. Computer 500 may include—or have access to a computing environment that includes—a variety of computer-readable media, such as volatile memory 514 and non-volatile memory 508, removable storage 510 and non-removable storage 512. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 500 may include or have access to a computing environment that includes input interface 506, output interface 504, and a communication interface 516. Output interface 504 may include a display device, such as a touchscreen, that also may serve as an input device. The input interface 506 may include one or more of a touchscreen, touchpad, mouse, keyboard, camera, one or more device-specific buttons, one or more sensors integrated within or coupled via wired or wireless data connections to the computer 500, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 500 are connected with a system bus 520.

Computer-readable instructions stored on a computer-readable medium are executable by the processing unit 502 of the computer 500, such as a program 518. The program 518 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 518 along with the workspace manager 522 may be used to cause processing unit 502 to perform one or more methods or algorithms described herein.

### EXAMPLES

1. A computer implemented method includes receiving a prompt and generating a query based on the prompt. A first data source having original data with different classifications is accessed to obtain first data source data responsive to the query. The obtained first data source data is processed to generate curated data. The curated data and prompt is provided to a large language model. A first language response is received from the large language model based on the curated data and the prompt.
2. The method of example 1 wherein processing the obtained first data source data to generate curated data is performed based on application of differential privacy and the different classifications of the original data.
3. The method of any of examples 1-2 wherein processing the obtained first data source data to generate curated data is performed based on role based access control of a user associated with the query.
4. The method of any of examples 1-3 and further including redacting the first language response based on a role-based access control (RBAC) level of a user associated with the prompt.
5. The method of any of examples 1-4 and further including redacting the first language based response on a role-based access control (RBAC) level of a user associated with the prompt and classification levels of original data included in the first language response.
6. The method of any of examples 1-5 and further including redacting the first language response based on a differential privacy associated with a user associated with the prompt.
7. The method of any of examples 1-6 and further including receiving additional knowledge data for training the large language model, processing the additional knowledge data to generate curated additional knowledge data with different classifications, and training the large language model on the curated additional knowledge data.
8. A machine-readable storage device has instructions for execution by a processor of a machine to cause the processor to perform operations to perform any of the methods of examples 1-7.
9. A device includes a processor and a memory device coupled to the processor and having a program stored thereon for execution by the processor to perform operations to perform any of the methods of examples 1-7.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the exampled subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving a prompt;
generating a query based on the prompt;
accessing a first data source having original data with different classifications to obtain first data source data responsive to the query;
processing the obtained first data source data to remove sensitive data to generate curated data;
providing the curated data and prompt to a large language model; and
receiving a first language response from the large language model based on the curated data and the prompt.

2. The computer implemented method of claim 1 wherein processing the obtained first data source data to generate curated data is performed based on application of differential privacy and the different classifications of the original data.

3. The computer implemented method of claim 1 wherein processing the obtained first data source data to generate curated data is performed based on role based access control of a user associated with the query.

4. The computer implemented method of claim 1 and further comprising redacting the first language response based on a role-based access control (RBAC) level of a user associated with the prompt.

5. The computer implemented method of claim 1 and further comprising:
redacting the first language based response on a role-based access control (RBAC) level of a user associated with the prompt and classification levels of original data included in the first language response;
adding the curated data; and
providing the redacted and curated data as an output.

6. The computer implemented method of claim land further comprising redacting the first language response based on a differential privacy associated with a user associated with the prompt

7. The computer implemented method of claim 1 and further comprising:
receiving additional knowledge data for training the large language model;
processing the additional knowledge data to generate curated additional knowledge data with different classifications; and
training the large language model on the curated additional knowledge data.

8. A machine-readable storage device having instructions for execution by a processor of a machine to cause the processor to perform operations to perform a method, the operations comprising:
receiving a prompt;
generating a query based on the prompt;
accessing a first data source having original data with different classifications to obtain first data source data responsive to the query;
processing the obtained first data source data to generate curated data;
providing the curated data and prompt to a large language model; and
receiving a first language response from the large language model based on the curated data and the prompt; and
redacting the first language response based on a differential privacy associated with a user associated with the prompt.

9. The device of claim 8 wherein processing the obtained first data source data to generate curated data is performed based on application of differential privacy and the different classifications of the original data.

10. The device of claim 8 wherein processing the obtained first data source data to generate curated data is performed based on role based access control of a user associated with the query.

11. The device of claim 8 wherein the operations further comprise redacting the first language response based on a role-based access control (RBAC) level of a user associated with the prompt.

12. The device of claim 8 wherein the operations further comprise redacting the first language based response on a role-based access control (RBAC) level of a user associated with the prompt and classification levels of original data included in the first language response.

13. The device of claim 8 wherein the operation further comprise redacting the first language response based on a differential privacy associated with a user associated with the prompt.

14. The device of claim 8 wherein the operation further comprise:
receiving additional knowledge data for training the large language model;
processing the additional knowledge data to generate curated additional knowledge data with different classifications; and
training the large language model on the curated additional knowledge data.

15. A device comprising:
a processor, and
a memory device coupled to the processor and having a program stored thereon for execution by the processor to perform operations comprising:
receiving a prompt;
generating a query based on the prompt;
accessing a first data source having original data with different classifications to obtain first data source data responsive to the query;
processing the obtained first data source data to generate curated data, wherein the processing comprises applying at least one of differential privacy role-based access control, and classification filtering to enforce privacy and access policies;
providing the curated data and prompt to a large language model; and
receiving a first language response from the large language model based on the curated data and the prompt;
providing the curated data and prompt to a large language model; and
receiving a first language response from the large language model based on the curated data and the prompt.

16. The device of claim 15 wherein processing the obtained first data source data to generate curated data is performed based on application of differential privacy and the different classifications of the original data.

17. The device of claim 15 wherein processing the obtained first data source data to generate curated data is performed based on role based access control of a user associated with the query.

18. The device of claim 15 wherein the operation further comprise redacting the first language response based on a role-based access control (RBAC) level of a user associated with the prompt or a user associated with the prompt and classification levels of original data included in the first language response.

19. The device of claim 15 wherein the operation further comprise redacting the first language response based on a differential privacy associated with a user associated with the prompt.

20. The device of claim 15 wherein the operation further comprise:
receiving additional knowledge data for training the large language model;
processing the additional knowledge data to generate curated additional knowledge data with different classifications; and
training the large language model on the curated additional knowledge data.
